(19) United States
(12) Patent Application Publication
(10) Pub. No.: US 2014/0150428 A1
(43) Pub. Date: Jun. 5, 2014

(54) HIGH-POWER TOWER RECEIVER CONFIGURATION

(71) Applicants: Jose Maria Mendez Marcos, Sevilla (ES); Raul Navio Gilaberte, Sevilla (ES)

(72) Inventors: Jose Maria Mendez Marcos, Sevilla (ES); Raul Navio Gilaberte, Sevilla (ES)

(21) Appl. No.: 13/880,011

(22) PCT Filed: Oct. 19, 2011
(86) PCT No.: PCT/ES11/70718

§ 371 Date: Jun. 21, 2013

(30) Foreign Application Priority Data
Oct. 20, 2010 (ES) P201001345

(51) Int. Cl. F03G 6/06

(52) U.S. Cl. CPC F03G 6/06
USPC 60/641.11; 60/641.15

(57) ABSTRACT

A receiver with a configuration of saturated and superheated steam solar modules in a tower solar concentration power plant. The configuration allows the incidence of radiation on both sides of the superheated steam module, providing significant benefits for its durability and global control of the power plant.

### CROSS-REFERENCES TO RELATED APPLICATIONS

This application claims the benefit of the Spanish patent application No. P201001345 filed on Oct. 20, 2010, the entire disclosures of which are incorporated herein by way of reference.

### BACKGROUND OF THE INVENTION

This invention concerns a configuration of the receivers in tower solar concentration plants with a physical separation between the evaporator, superheater, and the part for adaptive dynamic control of the heliostat field, in order to obtain superheated steam in an efficient and controlled manner, said configuration ensuring continued durability and normal operation of said solar plant in its various applications: electricity generation, process heat generation, solar fuel generation, and application to thermochemical processes.

The panel configuration proposed is valid for plants where the heat carrier fluid is water-steam or any other fluid that is technically equivalent such as oils, salts, etc., and which do not deviate from the essence of the invention or from the scope defined in the claims.

In order to increase the density of the solar radiation flow reaching the earth, use is made of solar thermal power plants (STPs), which enable the optical concentration of said radiation, making it possible to reach concentrations of up to 1,000 suns (1,000 times the direct solar radiation from the sun), and thus higher temperatures in the heat carrier fluids.

There are currently three main technologies developed for use in solar power plants: central receivers, parabolic trough collectors, and Stirling discs. All of them make use only of the direct component of solar radiation, which forces them to have sun monitoring devices.

1. Central receiver systems (3D) use mirrors with a large surface area (40-125 m2 per unit) known as heliostats, which have a control system to reflect direct solar radiation onto a central receiver located on the upper part of a tower. In this technology, concentrated solar radiation heats a fluid in the receiver to temperatures of up to 1,000° C., the thermal energy from which can be then be used to generate electricity.

2. In parabolic trough collectors (2D), direct solar radiation is reflected by parabolic through mirrors that concentrate it in a receiver pipe or absorber through which a fluid flows. This fluid heats up as a result of the concentrated solar radiation that impacts it at a maximum temperature of 400° C. In this way, solar radiation is turned into thermal energy, which is later used to generate electricity through a Rankine water/steam cycle. A variation of this technology is Fresnel linear concentration systems, in which the parabolic mirror is replaced by a Fresnel discretisation with smaller mirrors which can be flat or have a slight curvature in their axial axis, and which, by control of their axial orientation, make it possible to concentrate solar radiation on the absorber pipe, which in this kind of application usually remains fixed.

3. Stirling parabolic disc systems (3D) use a surface of mirrors mounted on a revolution parabola which reflect and concentrate sun rays on a specific focus, where the receiver in which the working fluid of a Stirling engine is heated. This engine, in turn, activates a small electrical generator.

In central receiver systems, water-steam technology is currently the most conventional one, as it has been used in such power plants as the Spanish CESA-1, PS10, and PS20 plants, and in the American Solar One power plant.

In PS10 and PS20 steam saturated steam is generated in the solar receiver at a temperature of 255° C. and 45 bar. The steam generated and mixed with saturated liquid is sent to a container where the separation between phases takes place, sending saturated steam to the turbine and the liquid back to the solar receivers.

In CESA-1 and Solar One steam is generated and superheated in the solar receiver at a temperature of 500° C. and 10 Mpa (100 bar), and directly sent to the turbine. In order to reduce transient impact (passing clouds, etc.) a storage system is used (molten salts in the CESA-1 power plant and an oil/rocks thermocline in Solar One). This concept was the first one to be tested as it allows the transposition of usual techniques in thermal plants and allows the steam exiting the solar receiver direct access to the turbine.

Use of superheated steam can allow the implementation of more efficient thermodynamic cycles in power plants.

The difficulty of solar technology for the generation of superheated steam lies in the demanding temperature conditions in which the receiver must operate. The walls of its pipes are continually subjected to thermal cycles between room temperature, the temperature of the steam supplied to this receiver (250 to 310° C.), and the wall temperature (higher than 600° C.) required for generation of superheated steam at 540° C. Unlike receivers that generate saturated steam at a common temperature for almost all of their parts (saturation temperature at the working pressure), of superheated steam receivers raise the temperature of their pipes the higher their proximity to the steam exit area

The difficulties encountered in the experiments carried out in the 1980s in the CESA 1 and Solar One superheated steam receivers focused mainly on two aspects:

Lack of system control, particularly in the case of transients, cloud passage, etc. mainly due to the bad thermal properties of superheated steam.

In both receivers, the most frequent structural flaw was the appearance of cracks. The thermal stress due to large temperature differences led to the appearance of cracks in the interstitial welding between subpanels. This situation arose mainly during stops, when water in a subpanel, at the saturation temperature, flowed towards the upper part, where the temperature was still that of the superheated steam, while this phenomenon did not appear in the adjacent subpanel.

The problem of working at high pressures, which requires thicker pipe walls, necessitating high thermal gradients to transfer high power densities to the heat carrier fluid.

Patent WO2008/012390 describes a solar energy boiler which uses a combination of saturated steam and superheated steam receivers in which there is a single active wall in the tower which the radiation collected by a heliostat field impacts, referring to the strong thermal stress to which the materials with the proposed configuration are subjected, the object of this invention being, among others, drastic reduction of this stress.

Analogously, patent US 2008/0078378 uses a trough receiver combining saturated and superheated steam receivers which, precisely due to their trough arrangement, have the aforementioned drawback that, due to heterogeneous temperature distribution, it requires special measures for protection against thermal stress in material, which has a negative impact on the receiver's service life.

### SUMMARY OF THE INVENTION

The invention described as follows tries to make use of the advantages of high-temperature steam, solving the aforementioned problems in the state of the art, achieving greater control over the power plant and thus favouring the stability and durability of the plant and its parts, mainly the receivers.

The high-power tower receiver configuration that is the object of this document solves the aforementioned problems, also providing other additional benefits which will be obvious from the following description.

The receiver configuration proposed can be composed of one or more areas or orientations with respect to the heliostat field, thus making maximum use of the incidence of solar radiation. Each receiver area comprises two or more mutually independent modules. These modules can be aimed at the generation of saturated steam, in case of central modules, or else at the superheating of this steam, in the case of the peripheral modules. The central and peripheral modules are located within either area, placed in such a way that the peripheral modules, given their peripheral position, would receive radiation both on their front and on their back sides, and that the central modules, given their central position, would received radiation only on their front side.

Each module, central of peripheral, is constituted of one or more panels.

These panels are constituted of horizontal or vertical pipes. Moreover, the outermost panels in each of the areas, given the position of the peripheral module, may be irradiated on both sides. Thus two areas share one single peripheral module.

The invention which is here described proposes a configuration for the central and peripheral modules that is valid for tower solar plants that use heliostats placed around the tower, with various focus points. The invention also includes heliostat field orientation strategies for both types of modules, central and peripheral, the strategies being flexible to change heliostat orientation from one type of module to another one as required.

These control strategies will consist in adaptive dynamic controls over the heliostat field for two purposes. The first purpose is to maintain optimal pressure and temperature conditions for entry into the turbine. The second purpose is to provide energy as homogeneously as possible to minimise thermal stress in the receiver panels. To this end, the heliostat field is oriented towards either module, central or peripheral, in either area, depending on current needs and the radiation available. Thus, part of the heliostat field will be oriented towards a central module and another part will be oriented towards a peripheral module, thus achieving greater control over the plant and greater plant stability.

Another benefit of this invention lies in the incidence of the radiation reflected by the heliostats on the front and back side of the peripheral modules for the generation of superheated steam.

Until now, generation of saturated steam has been successfully tested in panels where radiation impacted on only one side. In these cases, the high coefficient of convection achieved by the huge flows of saturated liquid in recirculation and the relatively low temperature of the fluid flowing through the evaporators prevent excessive metal temperatures.

However, for superheated steam receivers in which radiation only impacts on one side and through which steam circulates at a very high temperature, metal temperatures higher than 650° are expected in some areas.

The configuration described here makes it possible to reduce the metal temperature in the peripheral modules for generation of superheated steam, with the ensuing technical benefits.

When the peripheral modules receive radiation on both sides, for a certain thermal power, the flow peak (W/m2) can be reduced by half (if panel size is maintained) as the available receiver surface to be irradiated is twice as large (only one of the panel sides was previously used). On the other hand, if the panel size was reduced by half for a certain thermal power, the flow peak would be equal as in the case of a configuration with panels irradiated on one side, but the cost of the panels would be much lower as their size would be decreased by half. In this case, even if the flow peak is maintained, given that radiation reaches the panel in a much more uniform manner, (homogeneously on both sides), the thermal stress undergone by the panels will be much lower.

In any case, as the peripheral module has a more homogeneous heat supply than in the case of incidence on one side only, stress will be lower and deformation will be more uniform, thus achieving a longer service life of the materials.

The aforementioned benefits are also valid for cases in which the heat carried fluid is not water/steam. Thus, power plants using oils, salts, or any other fluid would also benefit from what was previously described.

### BRIEF DESCRIPTION OF THE DRAWINGS

To complement the previous description and in order to aid better understanding of the characteristics of the invention, a detailed description of a preferred embodiment will now be provided, on the basis of a number of drawings that accompany this descriptive report, in which, for purely orientation purposes and without restriction, the following has been represented:

FIG. 1 shows the scheme of a receiver configuration with four central modules and four peripheral modules. Radiation reaches the modules from all sides of the heliostat field, and, whereas radiation only impacts one of the sides of the central modules, the peripheral modules are impacted on both sides.

FIG. 2 shows a three-dimensional view of the receiver configuration proposed and the main equipment in a power plant of this nature.

### DETAILED DESCRIPTION OF THE PREFERRED EMBODIMENTS

In both figures, numerical references correspond to the following parts and items:

1. Heliostats.

2. Central Tower.

3. Areas (orientations).

4. Central modules.

5. Container.

6. Peripheral modules.

7. Solar radiation

The details, forms, dimensions, and other accessory items, as well as the materials used in the high-power tower receiver configuration that is the object of this invention may be replaced as required by others that are technically equivalent and do not deviate from the essence of the invention or the scope defined by the following claims.

This invention concerns a solar receiver configuration located in a tower, with various orientations (or areas).

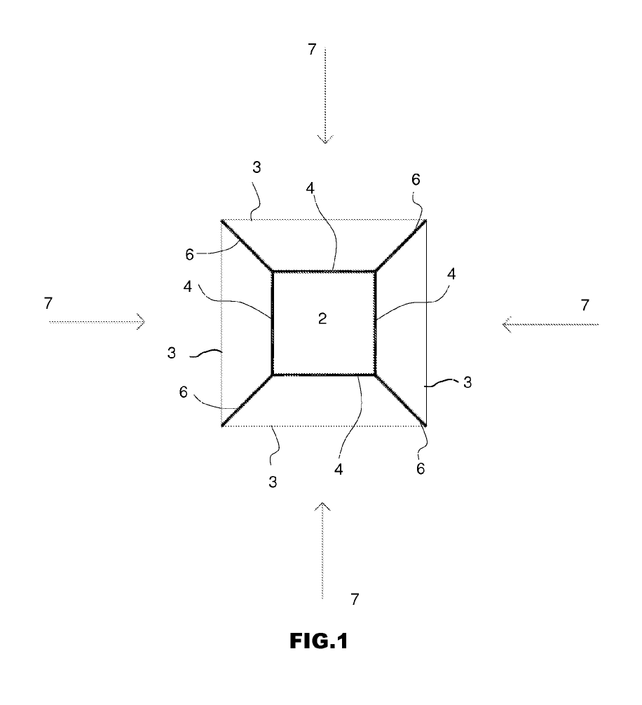

FIG. 1 depicts a preferred embodiment of the received by a solar power plant in accordance with this invention, composed of four areas (3), and a set of central modules (4) for the generation of saturated steam and a set of peripheral modules (6) for the superheating of the generated steam.

This preferred embodiment has the following design of the configuration or location of the modules on the top of the tower (2): four central modules (4) and peripheral modules (6), with the central modules (4) being oriented perpendicularly to each of the two modules by their side, and with the peripheral modules (6) forming an angle to each of the two central modules (4) by their side.

Each area (3) has three modules, a central module (4) and two peripheral modules (6), in such a way that the peripheral modules (6) are located on the outermost parts of each area (3). In this way, the peripheral modules (6), following this innovative configuration, would receive solar radiation (7) on both sides, with two areas (3) thus sharing the same peripheral module (6).

The invention described here also optimises the energy from the heliostat field (1) which is transferred in the central (4) and peripheral modules (6) to the fluid, as the configuration described makes it possible for the heliostats (1) distributed throughout the entire field to point towards a central module (4) or towards two different peripheral modules (6) as required.

This provides great flexibility when it comes to homogeneously distributing the energy from the heliostats (1), which changes depending on the time of day or weather conditions.

These imbalances can be compensated by the configuration of the central (4) and peripheral modules (6) and the heliostats (1), favouring the stability of the key process variables for power plant operation.

The configuration described also enables swift response to transients (passing clouds) or other contingencies relative to the solar field and simplifies its control requirements, as if a set of heliostats (1) located with the same orientation with respect to the tower (2) is affected by passing clouds, the decrease in power affects equally the central modules (4) and the peripheral modules (6) located in the same area, and so their steam production, thus removing the control problems resulting from discrepancies in the external conditions in both types of module, as the central (4) supplies the peripheral module (6).

This invention only requires minimum modification of the heliostat orientation and processing element control strategy (pumps and valves) to maintain pressure and temperature conditions at the peripheral module (6) exit in case of transients. The same would happen if there is an unavailability of heliostats (1) in one part of the field for any other reason. Any other receiver configuration in which the heliostats (1) in one part of the field are only oriented towards the central module (4) or the peripheral module (6) lacks this benefit.

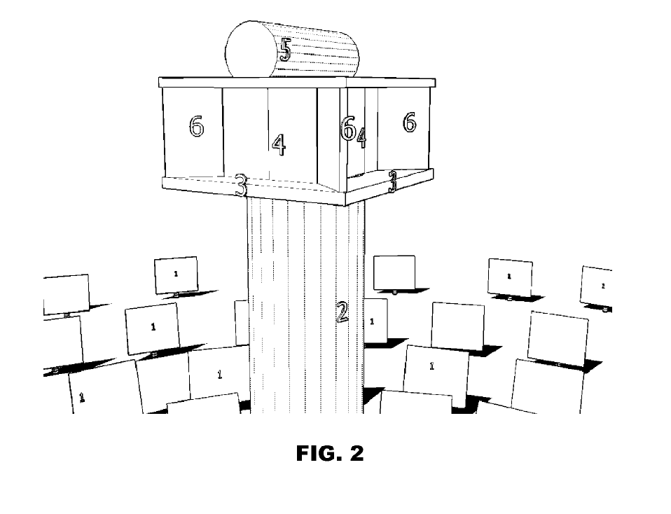

FIG. 2 includes a detail of a receiver in which the heat carrier fluid coming from the central modules (4) is superheated in the peripheral modules up to temperatures of about 540° C. Given their position, the peripheral modules (6) may be irradiated on both sides by the heliostat field (1), and thus two areas (3) share one single peripheral module (6). A container (5) is located between the central modules (4) and the peripheral modules (6), whose purpose is separating the liquid-phase water from the water steam entering the peripheral module.

Even though the description mentions steam as the heat carrier fluid, possible use of this receiver configuration for other types of fluid, such as molten salts, is not ruled out.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-14. (canceled)

15. A high-power tower receiver configuration, used in tower solar plants that have heliostat fields located around said tower receiver, which configuration comprises one or more areas, each area constituted at least by one central module and at least one peripheral module, each module having at least one panel exposed to the incidence of radiation reflected by at least one of the heliostats, the central module panels being only saturated steam panels, and the peripheral module panels being only superheated steam panels with a front side and a back side, each peripheral module being arranged at a certain angle with respect to an adjacent central module, such that, within a given area, each peripheral module receives radiation from the heliostats on both the front and back sides.

16. The high-power tower receiver configuration in accordance with claim 15, wherein the central modules and the peripheral modules are mutually independent.

17. The high-power tower receiver configuration in accordance with claim 15, wherein each peripheral module is located at a border between two adjacent areas.

18. The high-power tower receiver configuration in accordance with claim 15, wherein the tower receiver includes a plurality of areas and each central module is oriented perpendicularly with respect to a corresponding central module in an adjacent area.

19. The high-power tower receiver configuration in accordance with claim 15, wherein at least one of the central and peripheral modules comprise a plurality of panels.

20. The high-power tower receiver configuration in accordance with claim 15, wherein the panels each comprise horizontal or vertical pipes.

21. The high-power tower receiver configuration in accordance with claim 15, the tower receiver being placed within fields of heliostats wherein the heliostats direct solar radiation to a central module or to a peripheral module as required.

22. The high-power tower receiver configuration in accordance with claim 15, wherein the configuration comprises four areas, each area including three modules.

23. The high-power tower receiver configuration in accordance with claim 22, wherein each area includes one central module for the generation of saturated steam and two peripheral modules for the generation of superheated steam.

24. The high-power tower receiver configuration in accordance with claim 15, wherein each peripheral module is shared between two adjacent areas.

25. The high-power tower receiver configuration in accordance with claim 15, including a container located between the central module and the peripheral module which is configured to separate liquid-phase water from water steam entering the peripheral module.
